(19) United States
(12) Patent Application Publication
(10) Pub. No.: US 2008/0086552 A1
(43) Pub. Date: Apr. 10, 2008

(54) METHOD AND APPARATUS FOR DELIVERING PORTAL SERVICES

(75) Inventors: SREENIVASA GORTI, AUSTIN, TX (US); ANIL DORADLA, AUSTIN, TX (US); LALITHA SURYANARAYANA, AUSTIN, TX (US); DAVID WOLTER, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/539,801

(22) Filed: Oct. 9, 2006

(51) Int. Cl. G06F 15/173

(52) U.S. Cl. 709/223

(57) ABSTRACT

A method and apparatus for delivering portal services is disclosed. An apparatus that incorporates teachings of the present disclosure may include, for example, a portal having an aggregation element that presents aggregated IMS services of one or more IMS service providers to an IMS client operating in a terminal device. Additional embodiments are disclosed.

### RELATED APPLICATION

U.S. Patent Application, Attorney Docket Number 7785-139 (2006-782), filed Oct. 9, 2006, by Gorti et al., entitled “Method and Apparatus for Delivering IP Multimedia Subsystem Services,” incorporated herein by reference in its entirety.

### FIELD OF THE DISCLOSURE

The present disclosure relates generally to communication systems, and more specifically to a method and apparatus for delivering portal services.

### BACKGROUND

As IP Multimedia Subsystem (IMS) Services grow in popularity, an increasing number of data and multimedia applications are envisioned for fixed and mobile IP-based communication devices. Currently, each IMS application establishes a new user interface at a terminal device. This approach is similar to the days when each software application essentially had its own look and feel, thereby resulting in the creation of various windowing systems to address this problem.

Today's IMS services are deployed according to a static model. That is, communication devices operating in a wired or wireless access network (WAN) such as shown in the prior art system of FIG. 1 have one or more IMS clients and applications loaded in them that are pre-provisioned with credentials (e.g., user name/password, HTTP digest, etc.). Each IMS client is supplied by a corresponding IMS service provider. There can also be more than one IMS client for each IMS service supplied by an IMS service provider (e.g., one IMS client for location based services, one IMS client for Voice over IP services, and so on).

Each of these clients is pre-configured to point to a particular IMS service provider. The end user of a communication device utilizing these clients is thereby forced to subscribe with each corresponding IMS service provider on a fixed subscription. Additionally, each IMS client can independently utilize the resources operating in the communication device or in a system of the IMS service provider. Consequently, communications taking place between an IMS client and an IMS service provider's system can have redundant data exchanges (e.g., location information, presence information, and the like) in situations where the IMS clients need similar resources. Such communications are inefficient and result in unnecessary use of network bandwidth in the communication system from which the communication devices operate.

A need therefore arises for a method and apparatus that delivers portal services.

### BRIEF DESCRIPTION OF THE DRAWINGS

FIG. 1 depicts a prior art system for delivering services to communication devices;

FIG. 2 depicts an exemplary embodiment of a communication system;

FIG. 3 depicts an exemplary XML file descriptor for exchanging messages between a portal server and terminal device of the communication system;

FIG. 4 depicts an exemplary embodiment of a portal server and a terminal device operating in the communication system;

FIG. 5 depicts an exemplary method operating in portions of the communication system; and

FIG. 6 depicts an exemplary diagrammatic representation of a machine in the form of a computer system within which a set of instructions, when executed, may cause the machine to perform any one or more of the methodologies disclosed herein.

### DETAILED DESCRIPTION OF THE DRAWINGS

Embodiments in accordance with the present disclosure provide a method and apparatus for delivering IP Multimedia Subsystem (IMS) services.

In a first embodiment of the present disclosure, a computer-readable storage medium in a terminal device can have computer instructions for presenting IP Multimedia Subsystem (IMS) services of one or more IMS service providers by way of an IMS client supplied by a portal that aggregates one or more IMS services.

In a second embodiment of the present disclosure, a computer-readable storage medium in a portal can have computer instructions for aggregating and supplying one or more IMS services to an IMS client operating in a terminal device.

In a third embodiment of the present disclosure, a terminal device can have a presentation element that presents by way of a client one or more IMS services offered by a portal that aggregates one or more IMS services.

In a fourth embodiment of the present disclosure, a portal can have an aggregation element that presents aggregated IMS services of one or more IMS service providers to an IMS client operating in a terminal device.

In a fifth embodiment of the present disclosure, a method can be represented by an IMS service provider sharing revenue with a broker that aggregates one or more IMS services associated with the IMS service provider by way of a portal supplying said services to an IMS client.

In a sixth embodiment of the present disclosure, a method can be represented by a broker aggregating one or more IMS services for presentation to one or more terminal devices by way of a portal supplying said services to an IMS client operating in each of the one or more terminal devices.

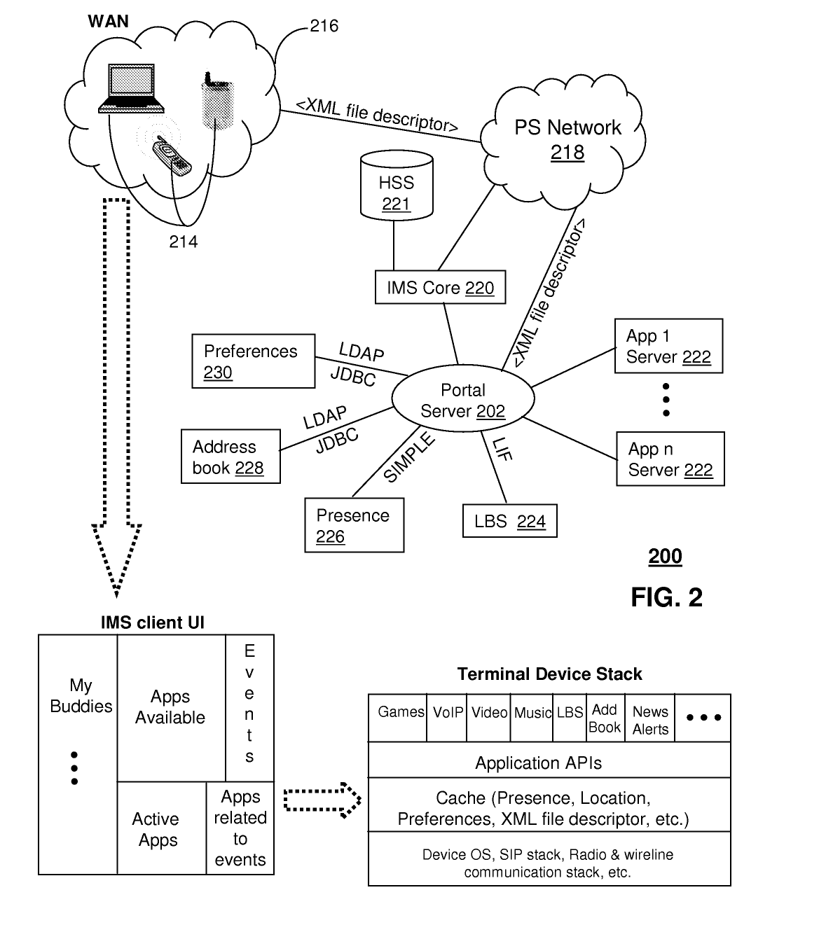

FIG. 2 depicts an exemplary embodiment of a communication system 200. The communication system 200 can comprise a number of Wireline or Wireless Access Networks (WANs) 216 which support any number of access technologies such as Public Switched Telephone Network (PSTN), xDSL, cable, WiFi, WiMAX, cellular (e.g., GSM, CDMA, UMTS, etc.), Bluetooth, software defined radio (SDR), ultra wide band (UWB), and so on. In one of several embodiments, WANs 116 can represent, for example, WiFi hotspots established by retailers to draw patrons to their establishment for additional business.

Terminal devices 214 can represent single or multimode roaming communication devices capable of interfacing to the WANs 216 by wire or wirelessly. The terminal devices 214 can represent a number of embodiments including without limitation computing devices (e.g., a laptop computer), a cellular phone with multimode capability (e.g., WiFi and cellular), and a personal digital assistant (PDA) with wireless capability. Accordingly, an end user of a terminal device 214 can operate from or roam into a WAN 214 of a residence or commercial enterprise and utilize wireless or wireline communication services of the communication system 200.

The WANs 216 can be coupled to a packet-switched (PS) network 218 (e.g., an IP, Frame Relay, Asynchronous Transfer Mode or ATM, Multi-protocol Label Switching or MPLS). The PS network 218 can be managed by, for example, a Tier 1 Internet Service Provider (ISP) utilizing common packet-switched routing technologies. A portal server 202 can be coupled to the PS network 218 to supply aggregated IP Multimedia Subsystem (IMS) services to roaming terminal devices 214 by way of the WANs 216.

IMS is a standardized Next Generation Network (NGN) architecture that converges mobile and fixed multimedia services. IMS can support Voice over IP (VoIP) based on a 3GPP (3^{rd} Generation Partnership Project) standardized implementation of Session Initiation Protocol (SIP), and can operate over a standard Internet protocol (IP) network. Existing phone systems utilizing packet-switched or circuit-switched techniques can be supported by IMS. Accordingly, IMS aims to provide current and future communication services that the Internet can support. In this way, IMS gives service providers the ability to control and charge for services in an integrated fashion. To achieve these objectives, IMS uses open standard protocols defined by the Internet Engineering Task Force (IETF).

Portal server 202 can be managed by an IMS services broker or aggregator. The portal server 202 can serve as a clearing house for IMS service providers targeting a large number of consumers by way of a large ISP. The portal server 202 can be operated by an independent broker, or can be managed by the service provider of the PS network 218. In some instances, the broker can be associated with one or more WANs 216 also. Consequently, the broker managing operations of the portal server 202 can be any of the parties providing communication services in FIG. 2. Due to the nature of terminal devices 214 roaming in and out of WANs 216, IMS services offered by the portal server 202 can be temporary or available at all times according to prearranged subscriptions.

In the illustration of FIG. 2, the portal server 202 is coupled to “n” application servers 222, a location-based services (LBS) server 224, a presence server 226, an address book server 228, a preferences server 230, an IMS core 220 and a home subscriber server (HSS) 221. The portal server 202 serves to aggregate IMS services from these sources including without limitation location services, remote address book management services, user preference services, presence management services, Voice over IP (VoIP) services, video conferencing services, and so on. The portal server 202 can interface to each of these servers through standard interfaces.

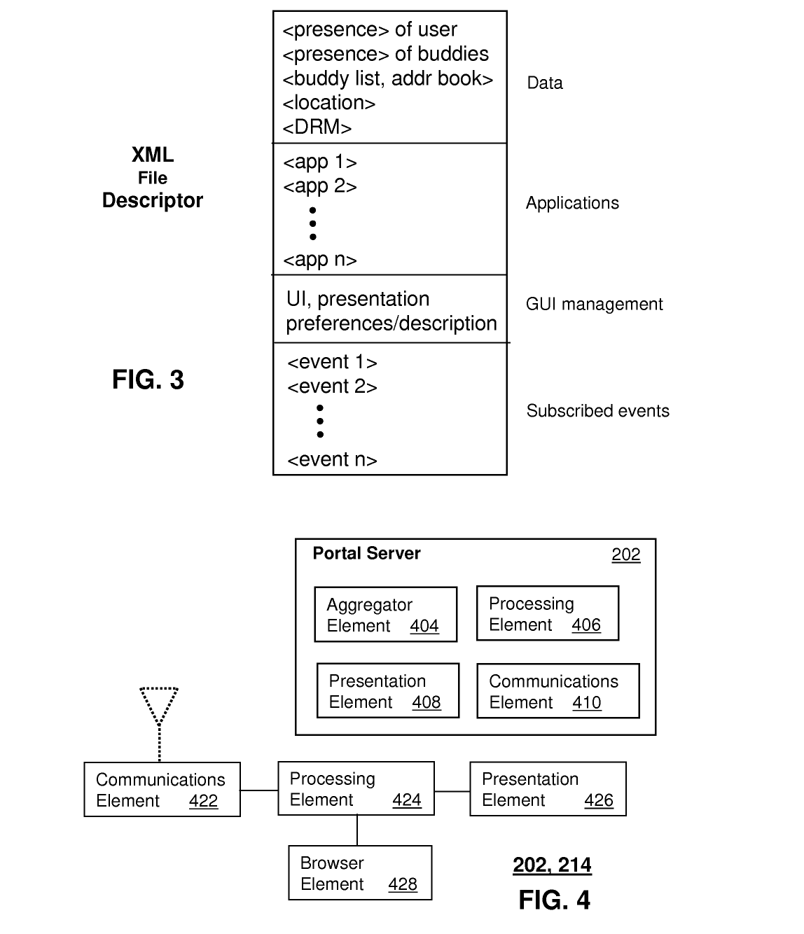

For example, the LBS server 224 can be accessed by way of a standard interface defined by the location interoperability forum (LIF). The presence server 226 can be accessed by way of a Session initiation protocol for Instant Messaging and Presence Leveraging Extensions (SIMPLE). The address book and preferences servers 228, 230 can be accessed using a Lightweight Directory Access Protocol (LDAP) and Java DataBase Connectivity (JDBC) protocol. The portal server 202 further manages its operations in cooperation with an IMS core 220 and subscription information stored in the HSS 221. Additionally, the portal server 202 and the terminal devices 214 can exchange messages using an eXtensible Markup Language (XML) file descriptor. A sample XML file descriptor is shown in FIG. 3.

The terminal devices 214 can present by way of a single IMS client a user interface (UI) that presents IMS services offered by the portal server 102. The UI can be subdivided into a number of Graphical User Interface (GUI) windows such as shown in FIG. 2. To support these operations, the terminal device 214 can be organized with a software stack such as shown in FIG. 2. The stack can comprise a layer of applications, Application Programming Interfaces (APIs), and a cache with a mechanism for updating data such as presence information, location information, user preferences, and the XML file descriptor—all of which operate on a device operating system (OS) platform that utilizes a Session Initiation Protocol (SIP) stack, radio and wireline communication stack, and so on.

To accomplish the foregoing activities, the portal server 202 can comprise an aggregator element 404, a processing element 406, a presentation element 408 and a communication element 410 as shown in FIG. 4. The aggregator element 404 serves to aggregate IMS services from one or more IMS service providers such as shown in FIG. 2 in an organized and scalable manner. The processing element 406 can represent a computing device (such as a scalable server) that manages operations of portal server 202. The presentation element 408 serves to present a web page of aggregated IMS services to roaming terminal devices 214 requesting service from portal server 202. The communication element 410 provides a means of communication between the IMS service providers and the PS network 218 utilizing common packet-switched technologies.

FIG. 4 also depicts an exemplary embodiment of the terminal device 214. Terminal devices 214 can comprise a communication element 422, a processing element 424, a presentation element 426, and a browser element 428. The communication element 422 can comprise common communications technology to support wireline and/or wireless communications conforming to the communication protocols previously described for the WANs 216. The processing element 424 can comprise a computing device such as a microprocessor and/or Digital Signal Processor (DSP) for managing operations of the terminal device 214. The presentation element 426 can comprise a common display such as a Liquid Crystal Display (LCD) accompanied by an audio system for presenting visual and/or audio signals to an end user of the terminal device 214. The browser element 428 can represent an IMS client supplied by the broker by way of the portal server 202 or pre-programmed in the terminal device 214 by other means for processing IMS services.

The foregoing elements of portal server 202 and the terminal device 214 can be implemented with common software and/or hardware techniques.

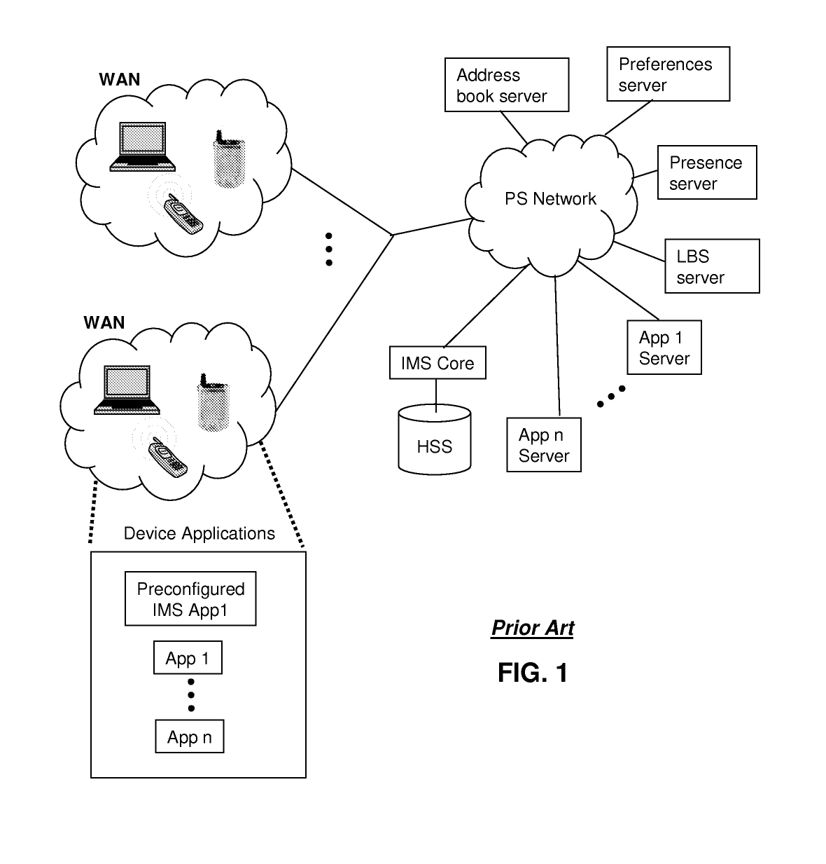

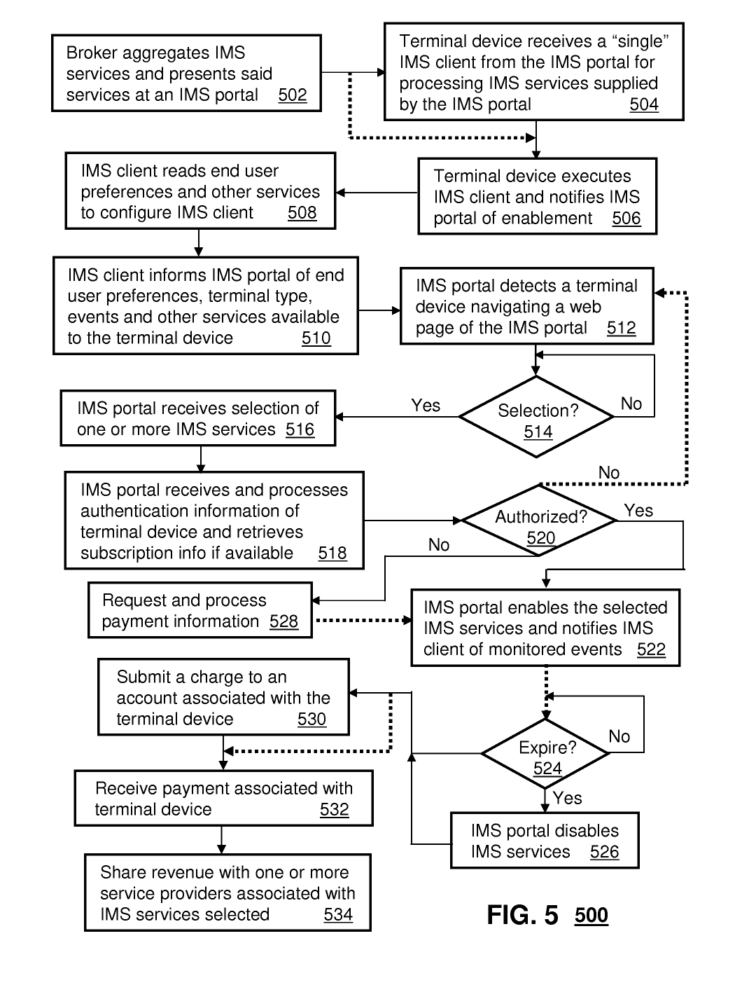

FIG. 5 depicts an exemplary method 500 operating in portions of the communication system 200. Method 500 begins with step 502 in which the portal server 202 aggregates a number of IMS services of one or more IMS service providers according to common aggregation techniques similar to the illustration of FIG. 2. This step can occur once or periodically as IMS services are added or removed by the broker of portal server 202. In step 504, the terminal device 214 receives a “single” IMS client from portal server 202 for processing IMS services supplied thereby. In a sense the IMS client serves as a universal IMS client for all IMS services supplied by the portal server 202. The downloading step can be performed by way of an HTTP browser download, or other means. Alternatively, the “universal” IMS client can be pre-programmed into the terminal device 114 at the time that it is purchased by the end user. In this embodiment, the IMS client differs from prior art systems such as shown in FIG. 1 in that it can support IMS services of multiple IMS providers supplied by the portal server 202.

The IMS client comprises a browser specifically tailored for IMS services that conform to a Session Initiation Protocol (SIP) or another suitable standard. In a supplemental embodiment, the IMS client can be enhanced to support services conforming to a Hyper Text Transfer Protocol (HTTP) also. In this embodiment, the IMS client serves as a hybrid SIP and HTTP browser in a single executable client. To avoid a situation in which each IMS service supports a different Graphical User Interface (GUI), an Application Programming Interface (API) is defined for the IMS client as noted in the stack configuration of FIG. 2. The API can define a number of libraries and GUI application calls so that any IMS service provider can adapt their IMS service to the IMS client. By defining broad API functions, IMS services can be processed by the IMS client through a generalized GUI in contrast to prior art systems such as in FIG. 1 requiring the utilization of multiple IMS clients each applying a proprietary GUI to support a corresponding IMS application. In the present embodiment, the IMS client can be implemented according to a well-known framework of standard languages and applications such as Java2 Micro Edition (J2ME), or a web services client such as Microsoft's .NET framework.

In step 506, the terminal device 214 can execute when prompted by an end user (or automatically upon power-up) the IMS client. Once enabled, the IMS client notifies the portal server 202 that it has been enabled. The IMS client can in step 508 read end user preferences stored in the terminal device 214 or remotely by way of the portal server 202, launch information supplied by the portal server 202, and other services if available such as location services, contact book, presence information, buddy lists, and so on to customize the configuration of the IMS client. The launch information supplied by the portal server 202 can consist of, for example, Uniform Resource Locators (URLs) to present IMS and/or HTTP icons and/or text by way of the generalized GUI of the IMS client (see sample IMS client UI in FIG. 2). To enhance the experience and more readily target the end user's needs, the IMS client in step 510 can be programmed to inform portal server 202 of the end user preferences, a terminal identification or type, services used by the terminal device 214, and other relevant events as they occur. Events can be exchanged with the portal server 202 by for example the XML file descriptor of FIG. 3 and/or by other suitable means.

In step 512, the portal server 202 can detect a terminal device 214 navigating a web page of the portal server 202 by common SIP and/or HTTP messages exchanged between the IMS client and the portal server 202. In step 514, portal server 202 awaits a selection from the terminal device 214. The IMS client provides an end user of the terminal device 214 a means to navigate through the web page to make one or more IMS and/or HTTP service selections. Once a selection is made, the terminal device 214 transmits the selected services to portal server 202, which is intercepted by the portal in step 516. In step 518, portal server 202 receives and processes authentication information supplied by the IMS client by way of, for example, an IMS Call Session Control Function (CSCF). The portal server 202 can also retrieve subscription information associated with the terminal 214 if available by way of the HSS 221. The subscription information can inform the portal server 202 of IMS and/or HTTP services which the end user may have already subscribed to.

The authentication information can comprise, for example, login information, a personal identification number or PIN code. The authorization information supplied by the terminal device 214 can be processed by portal server 202 according to a Remote Authentication Dial-In User Service (RADIUS) protocol. RADIUS is an Authentication, Authorization and Accounting (AAA) protocol for network access applications or IP mobility. Steps 520-522 can be used, for example, in cases where the terminal device 214 is an existing subscriber of portal server 202 for accessing IMS services while roaming in the communication system 200. If the authorization process fails in step 520, portal server 202 can proceed to step 512 where it can request that terminal 214 retransmit again the authentication information. Portal server 202 can alternatively send a notification to the end user of terminal device 214 indicating that authorization has been denied and that no further attempts are allowed if too many attempts have been made by said user.

Alternatively or in combination with steps 520-522, the portal server 202 can submit to the terminal device 214 a request for payment information. The payment information can represent a credit card, or prepaid card information. The end user of the terminal device 214 can enter payment information by common means such as a keypad, or the payment information can be pre-stored in the terminal device 214 and submitted to portal server 202 on demand. Once the payment information is received by portal server 202, it is processed in step 528. If valid, the portal server 202 proceeds to step 522 where it enables the one or more IMS services selected in step 516. The IMS client provides a visual indication (e.g., iconic or other message) of the IMS services selected and enabled. IMS service can represent any number of services including without limitation Voice over IP (VoIP), video and/or data services such as contact books, locations/maps, news feeds and so on.

Following step 522 the portal server 202 can temporarily enable the selected IMS services. The IMS services selected can be, for example, enabled over a 24 hour period with the ability to logoff and on to said IMS services multiple times, can be limited for use while the terminal device 214 is operating in the WAN 216 and terminated once its roams outside of the WAN's communication range, or can be enabled indefinitely depending on the end user's subscription. If enablement is temporary, in steps 524 and 526 portal server 202 can be programmed to check for the expiration of the IMS services selected. Once the IMS services have expired, portal server 202 can be programmed to disable said services, and if necessary remove the IMS client downloaded to the terminal 214.

From this point, the portal server 202 can proceed to step 530 where it can submit a charge to an account associated with the terminal device 214. In this embodiment, charges can be based on usage of IMS services rather than a fixed service fee. Accordingly, the portal server 202 does not submit a charge until it has made an accounting of the usage of IMS services and/or other interactions with the IMS services (e.g., content downloads) monitored by portal server 202. Once payment for said services is received by portal server 202 or the IMS service provider in step 532, revenue is shared between the broker managing portal server 202 and the IMS service provider associated with the IMS services selected in step 534 according to an agreement existing between the parties.

Upon reviewing the present disclosure, it would be evident to an artisan with ordinary skill in the art that the aforementioned embodiments can be modified, reduced, or enhanced without departing from the scope and spirit of the claims described below. For example, any number of protocols not presented herein can be used for exchanging messages between the IMS client and the portal server 202. Similarly, other common payment techniques not mentioned in the present disclosure can be applied without having an adverse effect on method 500 as described. These are but a few examples of modifications that can be applied to the present disclosure without departing from the scope of the claims. Accordingly, the reader is directed to the claims below for a fuller understanding of the breadth and scope of the present disclosure.

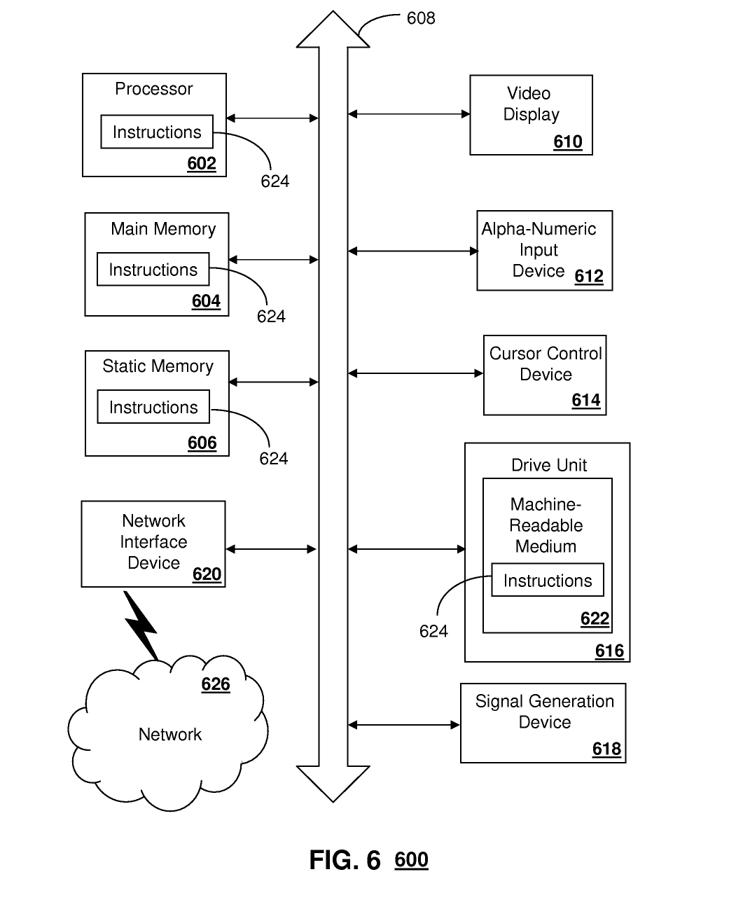

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a terminal device, comprising computer instructions for presenting IP Multimedia Subsystem (IMS) services of one or more IMS service providers by way of an IMS client supplied by a portal that aggregates one or more IMS services.

2. The storage medium of claim 1, comprising computer instructions for exchanging messages with the portal by way of eXtensible Markup Language (XML) messages.

3. The storage medium of claim 1, wherein the IMS client utilizes a Session Initiation Protocol (SIP) for communicating with the portal.

4. The storage medium of claim 1, wherein the IMS client comprises a browser for navigating through the IMS services supplied by the portal, and wherein the browser comprises an Application Programming Interface (API) for adapting the browser to said IMS services.

5. The storage medium of claim 4, wherein the browser conforms to a framework comprising one among a Java client framework, and a web services client framework.

6. The storage medium of claim 1, comprising computer instructions for receiving from the portal information associated with launching applications from the IMS client.

7. The storage medium of claim 1, comprising computer instructions for presenting by way of the IMS client IMS services according to user preferences retrieved by the IMS client from the terminal device.

8. The storage medium of claim 7, comprising computer instructions for conveying to the portal the user preferences for adapting the IMS services.

9. The storage medium of claim 1, comprising computer instructions for exchanging events between the IMS client and the portal.

10. The storage medium of claim 1, comprising computer instructions for supplying to the IMS services presented by the IMS client at least one among contact information, presence information, and location information retrieved from the portal.

11. The storage medium of claim 1, comprising computer instructions for presenting a Graphical User Interface (GUI) by way of the IMS client that identifies the IMS services available.

12. The storage medium of claim 1, comprising computer instructions for caching functions used by the IMS client.

13. The storage medium of claim 1, comprising computer instructions for notifying a portal that the IMS client has been enabled.

14. The storage medium of claim 1, wherein the one or more IMS services are supplied by one or more IMS service providers.

15. A computer-readable storage medium in a portal, comprising computer instructions for aggregating and supplying one or more IP Multimedia Subsystem (IMS) services to an IMS client operating in a terminal device.

16. The storage medium of claim 15, wherein the one or more IMS services correspond to one or more IMS service providers.

17. The storage medium of claim 15, comprising computer instructions for detecting enablement of the IMS client.

18. The storage medium of claim 15, comprising computer instructions for processing registration information supplied by the IMS client.

19. The storage medium of claim 15, comprising computer instructions for:
retrieving subscription information associated with the IMS client; and
supplying one or more IMS services to the IMS client according to the retrieved subscription information.

20. The storage medium of claim 15, comprising computer instructions for conveying one or more Uniform Resource Locators (URLs) to the IMS client for presenting at least one among one or more IMS services and one or more downloadable applications operated by the IMS client.

21. The storage medium of claim 15, comprising computer instructions for exchanging messages with the IMS client by way of eXtensible Markup Language (XML) messages.

22. The storage medium of claim 15, comprising computer instructions for exchanging events with the IMS client.

23. The storage medium of claim 15, comprising computer instructions for:
receiving from the IMS client an identification of the terminal device; and
tailoring the IMS services supplied to the IMS client according to the identification of the terminal device.

24. The storage medium of claim 15, comprising computer instructions for:
receiving user preferences from the IMS client; and
tailoring the IMS services supplied to the IMS client according to the user preferences.

25. The storage medium of claim 15, comprising computer instructions for supplying the IMS services to the IMS client in conformance with at least one among a Hyper Text Transfer Protocol (HTTP), and a Session Initiation Protocol (SIP).

26. A terminal device, comprising a presentation element that presents by way of a client one or more IP Multimedia Subsystem (IMS) services offered by a portal that aggregates one or more IMS services.

27. A portal, comprising an aggregation element that presents aggregated IMS services of one or more IMS service providers to an IMS client operating in a terminal device.

28. A method, comprising an IP Multimedia Subsystem (IMS) service provider sharing revenue with a broker that aggregates one or more IMS services associated with the IMS service provider by way of a portal supplying said services to an IMS client.

29. A method, comprising a broker aggregating one or more IMS services for presentation to one or more terminal devices by way of a portal supplying said services to an IMS client operating in each of the one or more terminal devices.
